(19) United States
(12) Patent Application Publication
(10) Pub. No.: US 2002/0132690 A1
(43) Pub. Date: Sep. 19, 2002

(54) Silent chain

(76) Inventors: Tadasu Suzuki, (US); Nobuto Kozakura, (US); Osamu Okabe, (US)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/091,986

(22) Filed: Mar. 6, 2002

(30) Foreign Application Priority Data
Mar. 13, 2001 (JP) 071169/2001

(51) Int. Cl. F16G 13/04

(52) U.S. Cl. 474/212

(57) ABSTRACT

A silent chain comprises a link assembly including at least two inner link plates each having a pair of teeth and bushing holes and connected and fixed to each other with a pair of bushings press-fit into said respective bushing holes, an intermediate link plate including a pair of teeth and bushing holes, and a guide plate including a pair of pin holes. The members are combined and articulably connected to by other with connecting pins. A row of link assemblies is disposed in the center with respect to the width direction of the chain and extends along the longitudinal direction of the chain. The intermediate link plates are disposed on both sides of the link assembly and guide plates are disposed on outer sides of each of the intermediate link plates. Each bushing in the link assembly disposed between said intermediate link plates has a length substantially equal to the spacing space between the intermediate link plates.

### BACKGROUND OF THE INVENTION

This invention relates to a silent chain used for power transmission, such as a timing drive chain in an automobile or motorcycle or a chain drive in a general purpose engine, diesel engine, industrial machine or the like. The invention relates more specifically to a silent chain used as a timing chain in an engine.

An example of a silent chain in use in conventional silent chain transmissions is the bushing-type silent chain shown in FIGS. 6(A) and 6(B). In this silent chain 11, guide plates 12, link assemblies 13 and intermediate link plates 16 are articulably interconnected to one another by connecting pins 17.

The guide plates 12 have no meshing teeth, but have a pair of pin holes 12a. Each link assembly 13 comprises two inner link plates 14, each having a pair of teeth 14a, which mesh with the teeth St of a sprocket (see FIGS. 8(A) and 8(B)), and a pair of bushing holes 14b as shown in FIG. 7(A). The two inner link plates 14 of each link assembly are integrally connected to each other by a pair of bushings 15. In this case, the bushings 15 are press-fit into the pair of bushing holes 14b formed in the inner link plates 14. Each intermediate link plate 16 include a pair of teeth which mesh with the teeth of a sprocket, and a pair of pin holes.

In the silent chain 11, intermediate link plates 16 are disposed in pairs, centrally with respect to the width of the chain, and in a row along the longitudinal direction of the chain. The link assemblies 13 are disposed on both sides of the row of intermediate link plates 16 in rows extending along the longitudinal direction of the chain, and the guide plates 12 are disposed on the outer sides of the link assemblies 13, that is on both outermost sides of the chain, and extending along the longitudinal direction of the chain, as shown in FIG. 6(A). The intermediate link plates, link assemblies and guide plates are shifted longitudinally with respect to one another, interleaved, and articulably connected to one another by connecting pins 17. The connecting pins 17 are press-fit into, and fixed to, the pin holes 12a in the guide plates 12 on the outermost sides of the chain. When the silent chain 11 is wound around a pair of sprockets, the guide plates on both outermost sides sandwich the sprocket teeth and thereby maintain the alignment of the chain with the sprockets.

In the conventional silent chain, the link assemblies 13 are disposed in two longitudinal rows, on both sides of the intermediate link plates. Thus, in the conventional silent chain, the parts count and the weight of the chain are both high, and the cost is also high. Further, since the link assemblies 13 are disposed in two separate rows in the longitudinal direction, at the location of each connecting pin, two short bushings 15 are arranged in side-by-side relationship in the width direction of the chain.

Therefore, when the silent chain 11, traveling around a sprocket, is under high tension, biased contact between the connecting pin 17 and the inner periphery or circumferential surface of the bushing 15 easily occurs, as shown in FIGS. 8(A) and 8(B). Then, since the silent chain is under high tension, wear of the connecting pin and the bushing is accelerated, and thus wear elongation of the silent chain is accelerated. Particularly, when biased contact between the connecting pin 17 and the inner periphery of the bushing 15 is generated in only one row of the link assembly as shown in FIG. 8(A), the balance of the silent chain deteriorates. Further, when the biased contact is generated on both rows of the link assemblies, the degree of the wear elongation of the silent chain is increased. FIGS. 8(A) and 8(B) are cross-sectional views corresponding to the cross-section taken along the surface X-X shown in FIG. 4.

### SUMMARY OF THE INVENTION

Accordingly, a general object of the invention is to overcome the problems associated with the above-mentioned conventional silent chain.

A more specific object of the invention is to provide a silent chain in which a reduction in the parts count and weight of a silent chain is attained, and the wear of the connecting pin and the bushing, and thus the wear elongation of the silent chain, can be suppressed.

According to one aspect of the invention, there is provided a silent chain comprising a link assembly including at least two inner link plates each having a pair of teeth and bushing holes and connected and fixed to each other by a pair of bushings press-fitted into the respective bushing holes, an intermediate link plate including a pair of teeth and bushing holes, and a guide plate including a pair of pin holes, the members being combined and articulably connected to one another by connecting pins, wherein a row of the link assembly, disposed centrally with respect to the width direction of the silent chain, extends along the longitudinal direction of the chain, the intermediate link plates are disposed on both sides of the link assembly, the guide plates are disposed on outer sides of the intermediate link plates, along the longitudinal direction of the chain, and each bushing in the link assembly disposed between the intermediate link plates has substantially the same length as that of the space between the intermediate link plates.

As mentioned above, a row of the link assembly is disposed centrally with respect to the width direction of the chain, and extends along the longitudinal direction of the chain. Thus, the link assembly count can be reduced as compared with that in a conventional silent chain. Accordingly, the total parts count of the link assembly can be reduced. As a result, a weight reduction in the chain, and a reduction in assembly man-hours can be realized.

Since the link assembly is disposed in a centrally located row, and intermediate link plates are disposed on the both sides of this link assembly, each bushing for the link assembly disposed between the intermediate link plates has substantially the same length as that of a space between the intermediate link plates. Thus, the silent chain of the invention can be twice as long as a conventional silent chain having the same number of link assemblies disposed in two rows. The longer length of the bushing allows the contact area between the connecting pin and the inner periphery of the bushing to be increased, and at the same time suppresses biased contact between the pin and the inner periphery of the bushing. As a result, wear of the connecting pin and bushing, and wear elongation of the chain, can be suppressed.

### BRIEF DESCRIPTION OF THE DRAWINGS

Preferred embodiments of the invention will now be described in detail with reference to the accompanying drawings, in which:

FIG. 1(A) is a plan view, partially in section, showing a part of a silent chain according to and embodiment the invention;

FIG. 1(B) is a side elevational view of the chain of FIG. 1(A);

FIG. 2(A) is a side view of a link assembly according to the invention;

FIG. 2(B) is a cross-sectional view of the link assembly;

FIG. 3 is a side elevational view of an intermediate link plate according to the invention;

FIG. 4 is a cross-sectional view showing the mesh between an inner link plate and sprocket teeth;

FIG. 5 is an explanatory cross-sectional view, taken on surface X-X in FIG. 4, showing the contact between the connecting pin and the inner periphery of the bushing;

FIG. 6(A) is a plan view, partially in cross-section, of a

FIG. 6(B) is a side elevational view of the conventional silent chain;

FIG. 7(A) is a side view of a conventional link assembly;

FIG. 7(B) is a cross-sectional view of the conventional link assembly;

FIGS. 8(A) and 8(B) are explanatory sectional views showing biased contact between the connecting pin and the inner periphery of the bushing; and

FIG. 9 is a graph showing the results of a test comparing elongation of the silent chains of the invention with elongation of conventional silent chains.

### DETAILED DESCRIPTION OF THE PREFERRED EMBODIMENTS

The following description is merely exemplary in nature and is in no way intended to limit the invention or its application or uses.

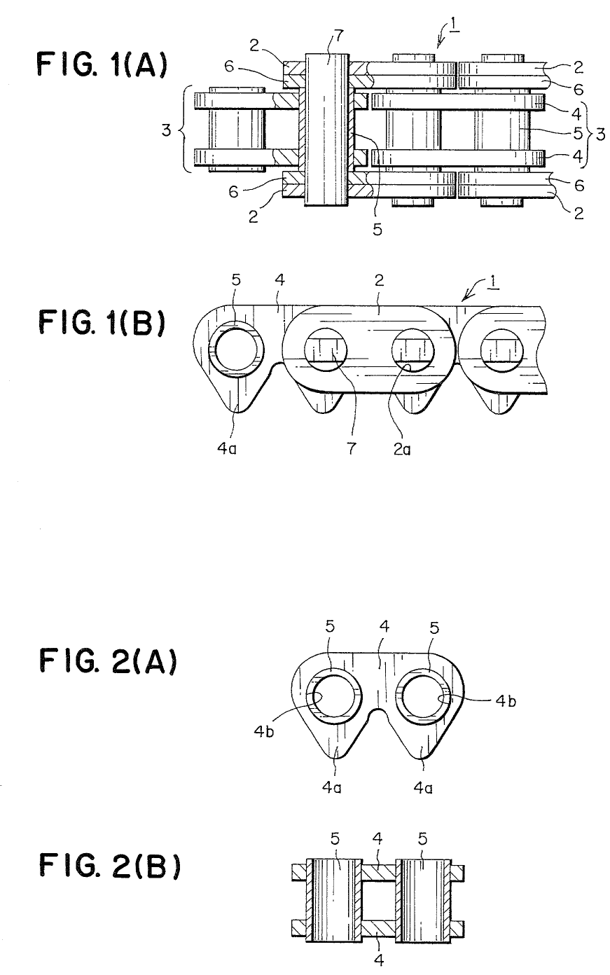

An embodiment of the invention will be described with reference to FIGS. 1(A) to 5. As shown in FIGS. 1(A) and 1(B), a silent chain 1 comprises guide plates 2, a link assembly 3 and outer link plates 6 interleaved with one another and articulably interconnected by connecting pins 7.

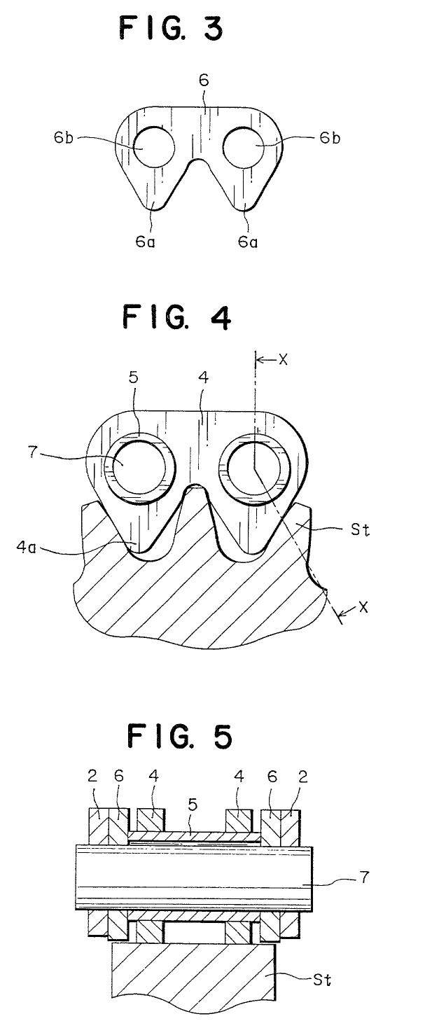

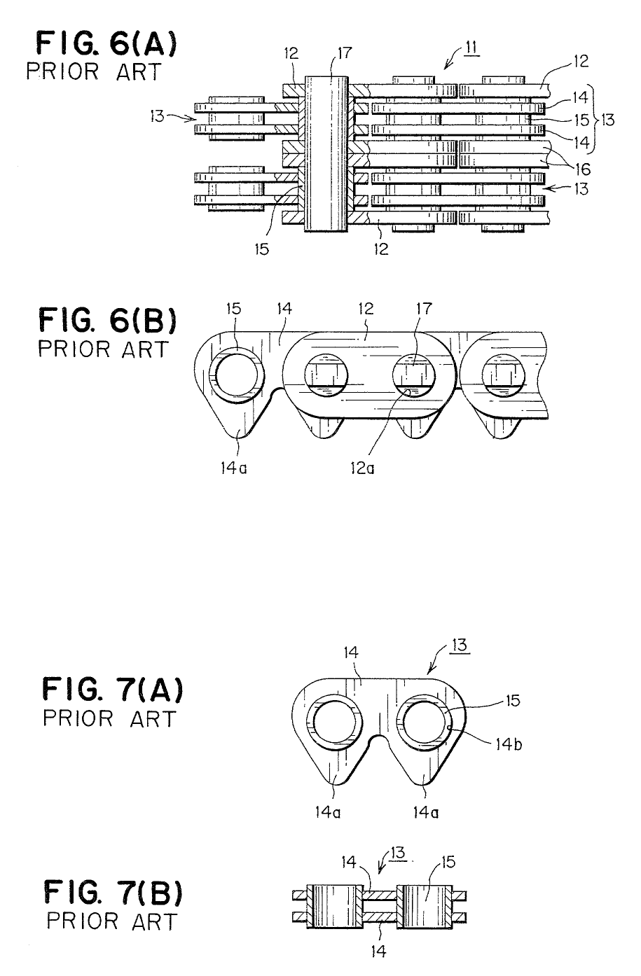

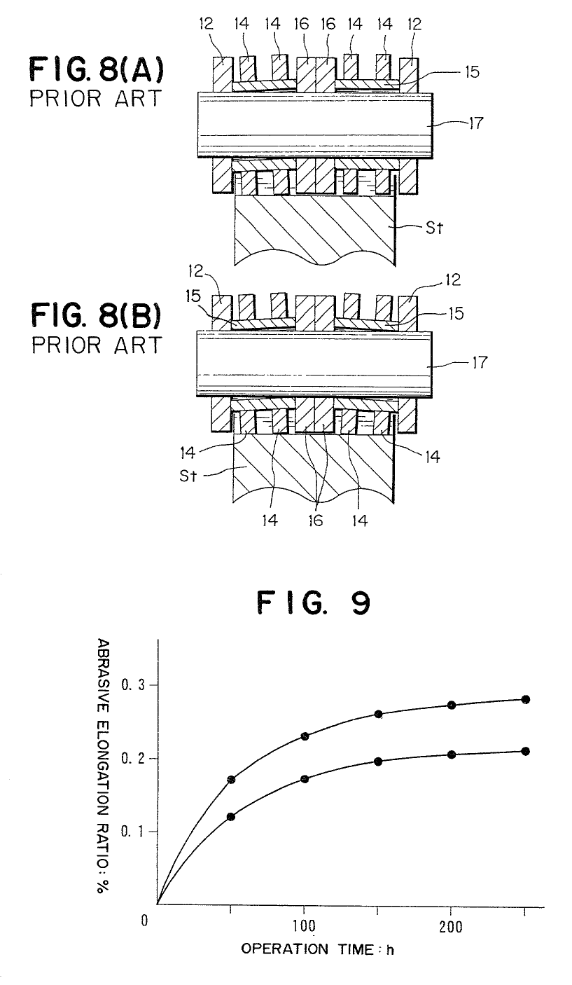

The guide plate 2 has no teeth for engagement with a sprocket, but has a pair of pin holes 2a. The link assembly 3 comprises two inner link plates 4, each having a pair of teeth 4a, which mesh with sprocket teeth, and a pair of holes 4b for receiving bushings 5. The link assembly 3 is integrally formed by connecting and fixing the two inner link plates, by press-fitting the bushings 5 into holes 4b in the respective inner link plates 4, as shown in FIGS. 2(A) and 2(B). Each of the intermediate link plates 6 includes a pair of teeth 6a (FIG. 3), which also mesh with a sprocket, and a pair of pin holes 6b. The teeth 6a of the intermediate link plates are of the same shape as the teeth 4a of the inner link plate 4.

As shown in FIG. 1(A), in the silent chain 1, a row of link assemblies 3 extends along the longitudinal direction of the chain in the center with respect to the width direction of the chain. The intermediate link plates 6 are disposed on both outer sides of the link assemblies 3, and the guide plates 2 are disposed on both outer sides of the intermediate link plates 6. These link assemblies 3, intermediate link plates 6, and guide plates 2 are shifted longitudinally with respect to one another so that they are interleaved, and are articulably connected to one another by the connecting pins. The connecting pins 7 are press-fit into and fixed in the pin holes 2a of the guide plates 2 on the outermost sides of the chain. When the silent chain 1 is wound around sprockets, the guide plates on the outermost sides sandwich the sprocket teeth and maintain the traveling line of the chain.

The link assemblies 3, which are arranged in a row in the center of the silent chain 1 are accommodated between the two rows of intermediate link plates 6, the space between the opposite link plates being just sufficient to accommodate the bushings of the link assemblies. Thus, the length of each bushing 5 is substantially the same as the width of the space between the intermediate link plates 6. When the silent chain 1 is wound around a sprocket, the bushing 5 has a length corresponding to the lengths of two bushings 15 of conventional link assemblies 13 of a conventional silent chain 11 designed for use on the same sprocket.

When the teeth 4a of the inner link plates 4, which forms the link assembly 3 of the invention, mesh with the sprocket teeth St, as shown in FIG. 4, biased contact between the connecting pin 7 and the inner periphery of the bushing 5 becomes less significant, due to a long length of the bushing 5. Thus, wear of both the connecting pin 7 and the inner periphery of the bushing 5 is suppressed, and at the same time the contact area therebetween becomes large. Accordingly, wear of the bushing and the connecting pin can be further suppressed, and as a result, wear elongation of the chain can be suppressed. Even if biased contact between the connecting pin 7 and the inner periphery of the bushing 5 is generated, the degree of the wear elongation of the silent chain is reduced because the biased contact is in a longer bushing.

Further, since the silent chain 1 has only a single row of link assemblies 3, the parts count of the link assemblies and the number of required link assemblies are reduced. Thus, a weight reduction in the silent chain, and a reduction in man-hours required for assembly of the silent chain, can be realized.

While the link assembly of the invention preferably comprises at least two inner link plates, another embodiment a link assembly may comprise three or more inner link plates instead of two inner link plates. Further, to enhance the wear resistance of the connecting pin, the connecting pin is preferably produced by subjecting pin stock to carburizing to obtain high carbon steel, or by subjecting the steel to heat treatment to form a metal carbide layer containing Cr, Ti, V, Nb or W on its surface.

Tests were conducted to compare the silent chain according to the embodiment of the invention illustrated in FIG. 1 and the conventional silent chain as shown in FIG. 9.

In the inner link plate, the intermediate link plate, and the guide plate in each of the silent chains tested, the pitch between the pin holes or between the bushing holes was about 9.525 mm, the diameter of the connecting pin was about 4.5 mm or less, the plate thickness of the intermediate link plate was about 1.3 mm, and the guide plate thickness was about 1.4 mm.

The plate thickness t of each of the two inner link plates of the invention, was about 1.6 mm, and the plate thickness t of each of the four inner link plates of the conventional silent chain was about 1.0 mm. The length of the bushing of the silent chain in accordance with the invention was about 9 mm, whereas the length of each of the bushings in the conventional silent chain was about 4.5 mm. In both cases the bushing plate thickness was about 0.7 mm, and the inner bushing diameter was about 4.5 mm or more.

The tests were carried out with a 21NT×42NT sprocket, a chain speed of about 19 m/s, and a chain tension of about 1.8 kN. The chain lengths were measured over time, after running the chain while lubricating it. The elongation ratio of the chain is the ratio of the elongation of the chain after the test to the original length of the chain. As can be seen from FIG. 9, the silent chains of the invention exhibited a significantly lower elongation ratio as compared with the conventional silent chains.

Obviously, various minor changes and modifications of the invention are possible in the light of the above teaching. It is therefore to be understood that within the scope of the appended claims, the invention may be practiced otherwise than as specifically described.

What is claimed is:

1. A silent chain comprising a row of link assemblies, each link assembly including at least two inner link plates, each having a pair of teeth and bushing holes, the inner link plates being connected and fixed to each other by a pair of bushings, each bushing being press-fit into bushing holes in the respective inner link plates, an intermediate link plate including a pair of teeth and bushing holes, and a guide plate including a pair of pin holes, the members being articulably connected to one another by connecting pins,
wherein said row of said link assemblies is disposed in the center with respect to the width direction of the chain and extends along the longitudinal direction of the chain, said intermediate link plates are disposed on both sides of said link assemblies in spaced relationship to each other, and said guide plates are disposed on outer sides of said intermediate link plates, the intermediate link plates and guide plates also extending in rows along the longitudinal direction of the chain respectively, and
each bushing in the link assembly is disposed between intermediate link plates on both sides of the link assemblies, and has a length substantially equal to the spacing between said intermediate link plates on both sides of the link assemblies.
